(19) United States
(12) Patent Application Publication
(10) Pub. No.: US 2022/0229607 A1
(43) Pub. Date: Jul. 21, 2022

(54) SYNCHRONIZATION OF APPLICATIONS INSTALLED IN EACH OF IMAGE FORMING APPARATUSES

(71) Applicant: Hewlett-Packard Development Company, L.P., Spring, TX (US)

(72) Inventor: Tae Hun KIM, Seongnam-si (KR)

(21) Appl. No.: 17/605,125

(22) PCT Filed: Apr. 6, 2020
(86) PCT No.: PCT/US2020/026834

§ 371 Date: Oct. 20, 2021

(30) Foreign Application Priority Data
Oct. 25, 2019 (KR) 10-2019-0133608

(51) Int. Cl. G06F 3/12; H04N 1/00; G06F 8/61

(52) U.S. Cl. CPC G06F 3/123; G06F 3/1231; G06F 3/1288; G06F 8/61; H04N 1/00973

(57) ABSTRACT

An example image forming apparatus includes a communication device to receive device information regarding image forming apparatuses included in a group to which the image forming apparatus belongs and application list information regarding an application list applied to the image forming apparatuses included in the group, and a processor to synchronize applications installed in the image forming apparatus based on the received application list information, and control the communication device to transmit the device information and the application list information to another image forming apparatus in the group to which the image forming apparatus belongs based on the device information.

### BACKGROUND

An image forming apparatus refers to an apparatus for printing print data generated by a print control terminal such as a computer onto a recording sheet. Examples of such an image forming apparatus include a copier, a printer, a facsimile, a scanner, or a multi-function printer that implements their functions in a single device.

Recently, the business-to-business (B2B) market in which printer management solution providers manage printers in government offices, universities, corporations, etc. is developing. In the B2B market, various applications may be installed in an image forming apparatus.

### BRIEF DESCRIPTION OF THE DRAWINGS

Various examples will be described below by referring to the following figures.

FIG. 1 is a block diagram illustrating a management system according to an example;

FIG. 2 is a block diagram illustrating a server according to an example;

FIG. 3 is a block diagram illustrating an image forming apparatus according to an example;

FIG. 4 is a block diagram illustrating an image forming apparatus according to an example;

FIG. 5 is a view illustrating group information and device information according to an example;

FIG. 6 is a view illustrating application list information according to an example;

FIG. 7 is a view illustrating group identifier information according to an example;

FIG. 8 is a flowchart illustrating an application management method in a server according to an example;

FIG. 9 is a flowchart illustrating an application management method in an image forming apparatus according to an example; and

FIG. 10 is a sequence view illustrating an application synchronization operation between a plurality of image forming apparatuses according to an example.

### DETAILED DESCRIPTION

Hereinafter, various examples will be described with reference to the accompanying drawings. Like reference numerals in the specification and the drawings denote like elements and thus a redundant description may be omitted. The examples described below may be modified and implemented in various different forms. In order to more clearly describe the features of the examples, detailed descriptions of matters well known to those skilled in the art to which the following examples belong will be omitted.

In the disclosure, when an element is described as “connected” with another element, this includes not only “directly connected,” but also “connected with another element therebetween.” In addition, when one element is described to “include” another element, this means that, unless specifically stated otherwise, it may further include other elements rather than excluding other elements.

In the disclosure, the term “image forming job” may refer to various tasks (e.g., printing, copying, scanning, or faxing) related to an image, such as forming an image or generating/storing/transmitting an image file, and the term “job” may refer not only to an image forming job but also a series of processes necessary for performing an image forming job.

In addition, “an image forming apparatus” may refer to an apparatus that prints printing data generated at a terminal apparatus like a computer on a recording medium such as paper. As examples of such an image forming apparatus, there is a copier, a printer, a facsimile, a scanner, or multi-function printer (MFP) that multiply implements the functions of the aforementioned apparatuses through one apparatus, etc.

Further, the term “server” may refer to a device that stores information provided by a plurality of devices. Examples of such a server include a management server that stores information on an operation state of a plurality of image forming apparatuses and manages each of the plurality of image forming apparatuses using the information, a file server that provides print data or contents to a plurality of image forming apparatuses, and the like.

In addition, the term “print data” may refer to data converted into a format printable by a printer.

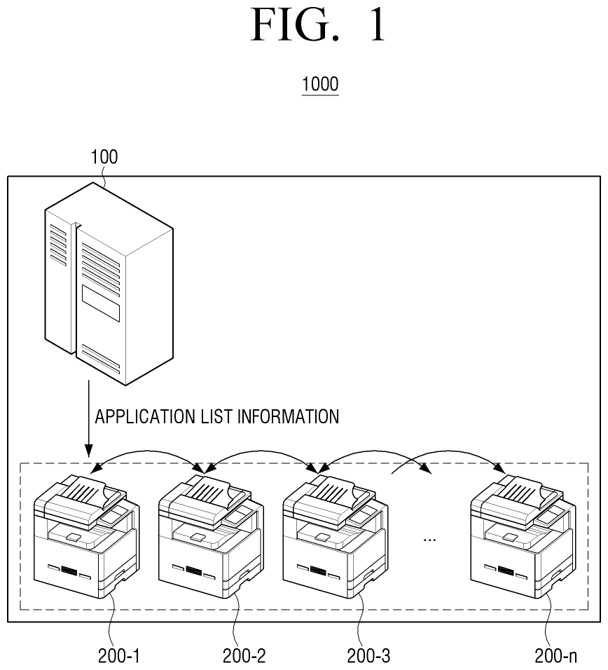

FIG. 1 is a block diagram illustrating a management system according to an example.

Referring to FIG. 1, a management system 1000 may include a server 100 and a plurality of image forming apparatuses 200-1, 200-2, 200-3, . . . , 200-n.

The server 100 may manage the connected image forming apparatuses 200-1, 200-2, 200-3, . . . , 200-n. For example, if the server 100 operates as a management server, the server 100 may collect information on the operation state of each of the connected image forming apparatuses 200-1, 200-2, 200-3, . . . , 200-n, and perform a management operation based on the collected information.

In addition, the server 100 may manage an application installed in each of the connected image forming apparatuses 200-1, 200-2, 200-3, . . . , 200-n. For example, the server 100 may allow a plurality of image forming apparatuses 200-1, 200-2, 200-3, . . . , 200-n in a group to have the same application on a group basis.

For this operation, the server 100 may generate application information, which may include information regarding an application to be applied by the image forming apparatuses 200-1, 200-2, 200-3, . . . , 200-n in a group, and device information, which may include information regarding image forming apparatuses to which the corresponding application information is to be applied.

The application information may include information regarding an application that may be installed commonly in each of the image forming apparatuses 200-1, 200-2, 200-3, . . . , 200-n, and may be in the form of a list. The application information may include policy information regarding a specific application.

For example, if the application information is in the form of a list, the application information may be referred to as application list information, and may have information on applications that should be installed in each of the image forming apparatuses in the form of a list. For example, if the application list information includes applications A, B, and C, only applications A, B, and C may be installed in the image forming apparatuses to which the corresponding application list information is provided.

The image forming apparatuses in a group may support different functions and the application list information may have different applications corresponding to different functions.

For example, one group may include image forming apparatuses only capable of supporting a printing function, or may include image forming apparatuses capable of supporting a printing function and a copy function as well. In order to be applicable in such a case, the application list information may be in the form of applications A, B, and C in relation to function 1 (printing function), applications E, F, and G in relation to function 2 (scanning function), and applications X and Z in relation to function 3 (copying function).

In this case, image forming apparatuses only capable of performing printing may perform synchronization using only the application list related to function 1, and image forming apparatuses supporting printing/scanning/copying may perform synchronization using all of the application lists related to functions 1, 2, and 3.

The application information may be policy information (or management information) indicating whether to maintain/update/delete a specific application and the corresponding application. In such a case, the application information may be referred to as application policy information.

For instance, the application policy information may be implemented as a policy of ‘application Z: delete’, and if such application policy information is provided to an image forming apparatus and the Z application is installed in the corresponding image forming apparatus, a synchronization operation of deleting the Z application may be performed.

If the application policy information has the policy of ‘application C: install’, the image forming apparatus that receives the corresponding application policy information and does not have application C installed may perform an operation of installing application C.

The above method may be combined with a function of an image forming apparatus. For example, the application policy information may be represented by a policy of ‘scan function: application D: install.’ In this case, an image forming apparatus that supports a scan function from among the image forming apparatuses that receive the corresponding application policy information may determine whether application D is installed, and if not, may perform an operation of installing application D.

The device information may include information regarding an application to which the above-described application information is to be applied. If a plurality of image forming apparatuses to which the above-described application information is commonly applied are referred to as a group, the above-described device information may be information regarding the image forming apparatuses that belong to the above-described group. Such device information may include address information, name, synchronization completion information, etc. of each image forming apparatus. The synchronization completion information may include information indicating whether application synchronization regarding the corresponding image forming apparatus is performed. The synchronization completion information may be bit information indicating synchronization completion or time information indicating synchronization timing.

The server 100 may transmit the generated device information and application information to the image forming apparatus 200-1. When distributing a new application, the server 100 may provide an installation file (e.g., an App package) regarding the new application together with the above-described information to the image forming apparatus 200-1. In an example, the device information, the application information, and the installation file may be distributed together by the server 100. In an example, the above-described installation file may be provided by another server or a device which is different from the server 100.

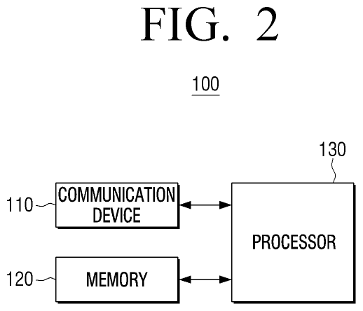

The server 100 may transmit the above-described device information and application information to each of the plurality of image forming apparatuses 200-1, 200-2, 200-3, . . . , 200-n, or may transmit the above-described device information and application information to only one image forming apparatus 200-1. An example of a server and operation of the server will be described with reference to FIG. 2.

Each of the plurality of image forming apparatuses 200-1, 200-2, 200-3, . . . , 200-n may install, update, or delete an application according to the management policy of the server 100. For example, each of the plurality of image forming apparatuses 200-1, 200-2, 200-3, . . . , 200-n may receive the device information and the application information, and an application may be synchronized among the image forming apparatuses 200 in the group based on the received device information and application information.

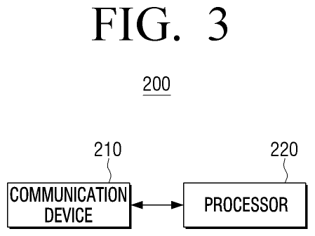

Each of the plurality of image forming apparatuses 200-1, 200-2, 200-3, . . . , 200-n may transmit the received device information and application information to another image forming apparatus when synchronization is completed according to the received information. When the synchronization of all the image forming apparatuses 200-1, 200-2, 200-3, . . . , 200-n in the device information is completed, the last image forming apparatus 200-n in the device information may notify the server 100 that the synchronization is completed. An example of an image forming apparatus and operation of the image forming apparatus will be described with reference to FIG. 3.

According to an example, the management system 1000 may manage applications installed in a plurality of image forming apparatuses in a server. For example, installation of an application for a plurality of image forming apparatuses may be managed by group rather than by individual units, so the manager convenience can be improved.

In addition, the management system 1000 performs a synchronization operation by sequentially transmitting the device information and the application information received between a plurality of image forming apparatuses and thus, if the server is connected to an external network which is different from that of the plurality of image forming apparatuses, the network traffic for transmitting the above-identified information may be reduced.

Although FIG. 1 illustrates an example in which the server 100 manages only the image forming apparatuses 200 that belong to one group, the server 100 may divide a plurality of image forming apparatuses into a plurality of groups and manage the plurality of groups.

In addition, FIG. 1 describes an example in which the server 100 provides an installation file. However, in other examples, the installation file may be provided by a separate file server which is physically separated from the server 100.

In addition, FIG. 1 illustrates an example in which, when synchronization is processed, each image forming apparatus only transmits the information to another image forming apparatus. However, in other examples, the synchronization operation may be performed in two or more units. For example, odd and even number devices in the device information may perform the synchronization operation simultaneously.

FIG. 2 is a block diagram illustrating a server according to an example.

Referring to FIG. 2, the server 100 may include a communication device 110, a memory 120, and a processor 130.

The communication device 110 (e.g., transceiver) may connect the server 100 to an external device. In various examples, the communication device 110 may connect the server 100 to an image forming apparatus 200 through a local area network (LAN), a Universal Serial Bus (USB) port, a wireless communication network, etc.

The communication device 110 may transmit device information and application information to an image forming apparatus 200. The communication device 110 may also transmit an installation file corresponding to a new application to an image forming apparatus 200.

In an example, the installation file may use not only a software package (e.g., an MSI file) but also a software source itself which is executed as a user executes an execution file directly such as a general software folder structure (e.g., a folder including a plurality of files), a compressed file (e.g., zip, exe), etc.

The communication device 110 may receive a synchronization result. For example, the communication device 110 may receive a synchronization result in response to the transmission of the above-described device information or application information. Such a synchronization result may be received for each image forming apparatus, or may be received from one image forming apparatus.

The communication device 110 may receive a management policy regarding an application from a user or a manager. In an example, the management policy may be a policy regarding whether to newly install/update/delete a specific application and may include information regarding applications to be commonly installed in the corresponding apparatuses.

At least one instruction regarding the server 100 may be stored in the memory 120. For instance, the memory 120 may store various programs (or software) necessary to operate the server 100 according to various examples.

The memory 120 may store information regarding a connectable image forming apparatus 200. Here, the connectable image forming apparatus 200 may be registered as a manager/user searches or finds the image forming apparatus 200 that belongs to a network, or the image forming apparatus 200 may be registered when the image forming apparatus 200 accesses the server 100 for the first time.

The memory 120 may store group information. In an example, the group information includes information regarding groups that will be managed commonly. The group information may include information regarding image forming apparatuses that belong to the corresponding group. Conversely, information regarding to which group the above-described image forming apparatus belongs may be included. In addition, the group information may include information regarding an application to be applied to the corresponding group.

The memory 120 may store generated device information and application information. In addition, the memory 120 may store an installation program regarding an application.

The processor 130 may control an operation of the server 100. For example, the processor 130 may control an operation of the server 100 by executing at least one instruction stored in the memory 120.

The processor 130 may generate group information. For example, the processor 130 may generate a group for each management target. Such group information may include a name of a group and identifier information of the group. The grouping operation may be performed by the selection of a user or a manager, or the processor 130 may automatically group the registered image forming apparatuses based on information such as a device name, an IP address, etc.

The processor 130 may generate information regarding an image forming apparatus that belongs to one of the above-described groups, that is, device information. Such device information may be information in which a device name and an IP address of each of the image forming apparatuses that belong to a specific group are arranged in order.

The processor 130 may generate application information. For example, the processor 130 may generate information regarding an application selected by a user or a manager as application information. Such application information may be applied to one group or a plurality of groups. One piece of application information may be applied to one group or a plurality of pieces of application information may be applied.

The processor 130 may perform authentication processing with respect to each of the device information and the application information. In other words, the processor 130 may perform authentication processing so as to confirm that the image forming apparatus receiving the above-described information that is generated and distributed by the server 100 is an authorized image forming apparatus.

For example, as an authentication processing method, encryption data may be transmitted so that an authentication key may be used, or separate authentication processing may be performed. For example, when the image forming apparatuses 200 are registered with the server 100 for the first time, the server 100 may issue a certificate, and the certificate may be used in communication between the server 100 and the image forming apparatuses 200. The image forming apparatuses 200 may authenticate whether the received device information and the application list information are provided by the server using a public key for the certificate.

When the above-described information is generated, the processor 130 may control the communication device 110 to transmit the above-described information to one of a plurality of image forming apparatuses that belong to a group. Here, the selected image forming apparatus may be an image forming apparatus listed at the top of the device information.

The processor 130 may update the application information or the device information or may perform a synchronization operation of the above-described application at predetermined periods.

According to an example, the server 100 may manage an application of each of a plurality of image forming apparatuses through a single setting process.

FIG. 3 is a block diagram illustrating an image forming apparatus according to an example.

Referring to FIG. 3, the image forming apparatus 200 may include a communication device 210 and a processor 220.

The communication device 210 (e.g., transceiver) may connect the image forming apparatus 200 to an external device. As an example, the communication device 210 may connect the image forming apparatus 200 to the server 100 or to another image forming apparatus through a Local Area Network (LAN), an Internet network, a USB port, etc.

The communication device 210 may receive print data related to a print job.

The communication device 210 may receive device information and application information. In addition, the communication device 210 may receive an installation file corresponding to a new application. Such device information, application information, and installation file may be received directly from the server 100 or from another image forming apparatus.

For example, the first image forming apparatus 200-1 of the device information may receive the above-described information directly from the server 100 and perform application synchronization based on the received information. Once the application synchronization is completed, the received device information and application information may be provided to another image forming apparatus.

In an example, the above-described first image forming apparatus 200-1 may serve to provide the above-described information to the other image forming apparatuses 200-2, 200-3, . . . , 200-n (that is, serving as a hub), or it may be configured that the first image forming apparatus 200-1 transmits the information to the second image forming apparatus 200-2, the second image forming apparatus 200-2 transmits the information to the third image forming apparatus 200-3, etc.

In an example, the above-described device information and application information are sequentially transmitted. For example, the installation file may be provided by the first image forming apparatus 200-1 to another image forming apparatus when a request is made by the other image forming apparatus.

In an example, if there is an error in the second image forming apparatus 200-2 or if the second image forming apparatus 200-2 is turned off, the first image forming apparatus 200-1 may skip the second image forming apparatus 200-2 at the time of transmission of the information and transmit the received information to the third image forming apparatus 200-3.

In this case, the third image forming apparatus 200-3 determines whether information can be transmitted to the second image forming apparatus 200-2 after the completion of synchronization and, if possible, may transmit the above-described information to the second image forming apparatus 200-2. In an example, the skipped image forming apparatus may be synchronized in the last step after final confirmation, and the image forming apparatus in which an error occurs may be adjusted to a lower rank in the above-described device information.

The processor 220 may control each element of the image forming apparatus 200. For example, the processor 220 may control an operation of the image forming apparatus 200 by executing at least one instruction stored in a memory.

When receiving application information through the communication device 210, the processor 220 may synchronize the application installed in the image forming apparatus 200 to correspond to the received application information. For example, if application list information having information regarding A, C, and D while applications A, B, C, and D are installed in the image forming apparatus 200, the processor 220 may delete application B which is not included in the application list information or limit access to application B so that application B does not appear in the available application list if application B cannot be installed.

If application information includes policy information such as ‘application D: delete’, that is, if the application policy information is received, the processor 220 may determine whether application D is installed in the image forming apparatus 200. If it is determined that application D is installed, the processor 220 may delete the corresponding application.

If application list information having information regarding A, B, C, and D is received or application policy information to install application D is received while applications A, B, and C are installed in the image forming apparatus 200, the processor 220 may install application D. If an installation file regarding application D is transmitted together with the above-described device information and application information in order to install application D, the installation can be performed immediately using the previously-received installation file.

If the installation file is not received, the processor 220 may request the first image forming apparatus in the device information or another image forming apparatus that transmits the application information to send the installation file and receive the same. In response to receiving the installation file as a result of such a request, the processor 220 may proceed with the installation using the received installation file.

Once the application synchronization is completed, the processor 220 may control the communication device 210 to transmit the received application information and device information to another image forming apparatus. In this case, the processor 220 may update the synchronization completion information in the device information (i.e., indicate that the synchronization of the current image forming apparatus is completed), and transmit the updated device information and application information to the image forming apparatus described next to the current image forming apparatus in the group information.

If the current image forming apparatus is the last apparatus in the device information, the processor 220 may control the communication device 210 to notify the server 100 that the synchronization is completed.

In an example, if the image forming apparatus 200-1 serves as a hub device in the group, the processor 220 may transmit the application information to each of the other image forming apparatuses 200-2, 200-3, . . . , 200-n in the group based on the device information to synchronize an application of each of the image forming apparatuses. If the synchronization of all the image forming apparatuses (including itself) in the device information is completed, the processor 220 may control the communication device 210 to transmit synchronization completion information indicating that the synchronization is completed. In an example, the notification of the completion of synchronization may be notified to each of the image forming apparatuses 200 individually.

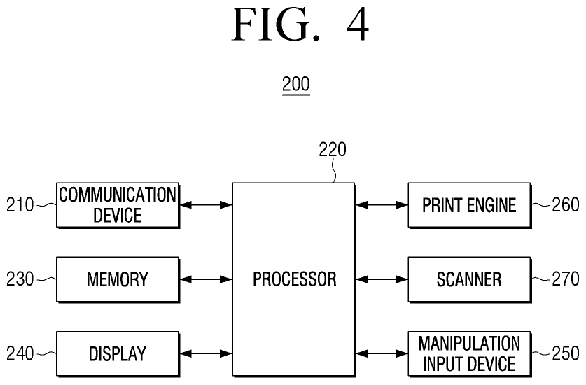

In the above description, an image forming apparatus is illustrated and described. In other examples, various elements may be added. Such an example will be described with reference to FIG. 4.

FIG. 4 is a block diagram illustrating an image forming apparatus according to an example.

Referring to FIG. 4, the image forming apparatuses 200 may include the communication device 210, the processor 220, a memory 230, a display 240, a manipulation input device 250, a print engine 260, and a scanner 270.

Since the communication device 210 has been described above with reference to FIG. 3, an overlapping description will not be provided. The processor 220 has also been described with reference to FIG. 3 and thus, an overlapping description will not be provided. Only those elements added in FIG. 4 will be described below.

The memory 230 may store at least one instruction regarding the image forming apparatus 200. For example, the memory 230 may store various programs (or software) necessary to operate the image forming apparatus 200 according to various examples. For instance, the programs may include applications using at least one function of the image forming apparatus 200 and an operating system to operate the above-described applications. In an example, the operating system may support an open platform.

In an example, the open platform may manage applications installed in the image forming apparatus 200. A module on the open platform that performs such a management function may be referred to as an Application Management System (AMS). The AMS manages a list of applications installed in the image forming apparatus 200, and, if the application list information is received as described above, the operation of delete/install/update the application may be performed based on the received application information.

The memory 230 may store a list of applications installed in the above-described operating system. In addition, the memory 230 may store print date received through the communication device 210. Further, the memory 230 may store the received device information and application information.

The memory 230 may store a received installation program. Such an installation program may use not only a software package (e.g., an MSI file) but also a software source itself which a user directly executes to install an installation file, such as a general software folder structure (e.g., a folder including a plurality of files), a compressed file (e.g., zip, exe), etc.

The memory 230 may be implemented as a storage medium in the image forming apparatus 200 or an external storage medium. For example, the memory 230 may be implemented as a removable disk including a USB memory, a web server via a network, etc.

The display 240 includes a plurality of function keys which allows a user to set or select various functions supported by the image forming apparatus 200 and may display various information provided by the image forming apparatus 200. The display 240 may be a monitor such as Liquid Crystal Display (LCD), a Cathode Ray Tube (CRT), a Light Emitting Diode (LED), an Organic LED (OLED), etc. or may be implemented as a touch screen capable of performing the function of the manipulation input device 250 simultaneously.

The manipulation input device 250 may receive a selection of a function and a control command regarding the corresponding function from a user. Here, the function may include a print function, a copy function, a scan function, a fax transmission function, etc.

The print engine 260 may form an image. For example, the print engine 260 may print a print image generated by the processor on a printing medium such as paper. In an example, the print engine 260 may perform printing using an electrophotographic method, an inkjet method, etc. In addition, the print engine 260 may be a mono print engine capable of printing only one color or may be a color print engine capable of performing color printing.

The scanner 270 may read a manuscript and generate a scan image.

The image forming apparatus 200 may perform not only a print function but also scan function and a copy function. In an example, a group may include various image forming apparatuses such as an image forming apparatus only capable of a print function and an image forming apparatus capable of performing a scan function as well.

Accordingly, in order to respond to such various image forming apparatuses, the above-described application list information may include a plurality of functions and list information on applications to be synchronized for each of the functions. For example, the application list information including applications A, B, and C for a print function, applications E, F, and G for a scan function, and application Z for a copy function may be transmitted in a group.

In this case, the image forming apparatus capable of performing only a print function may perform a synchronization operation using only applications A, B, and C corresponding to the print function. The image forming apparatus capable of a scan function and a copy function may perform a synchronization operation regarding list information of all applications A, B, C, E, F, G, and Z in the above-described device information.

If print data is received through the communication device 210, the processor 220 may control the print engine 260 to print the received print data.

As such, the image forming apparatus may perform synchronization of applications by transmitting and receiving necessary information in the image forming apparatus of a group and thus, may reduce network traffic between the image forming apparatuses and a server.

In describing FIGS. 3 and 4, after completion of application synchronization in the image forming apparatuses, the device information and the application information is transmitted to another image forming apparatus. However, the above-described information may be transmitted preferentially to another image forming apparatus during or prior to the synchronization.

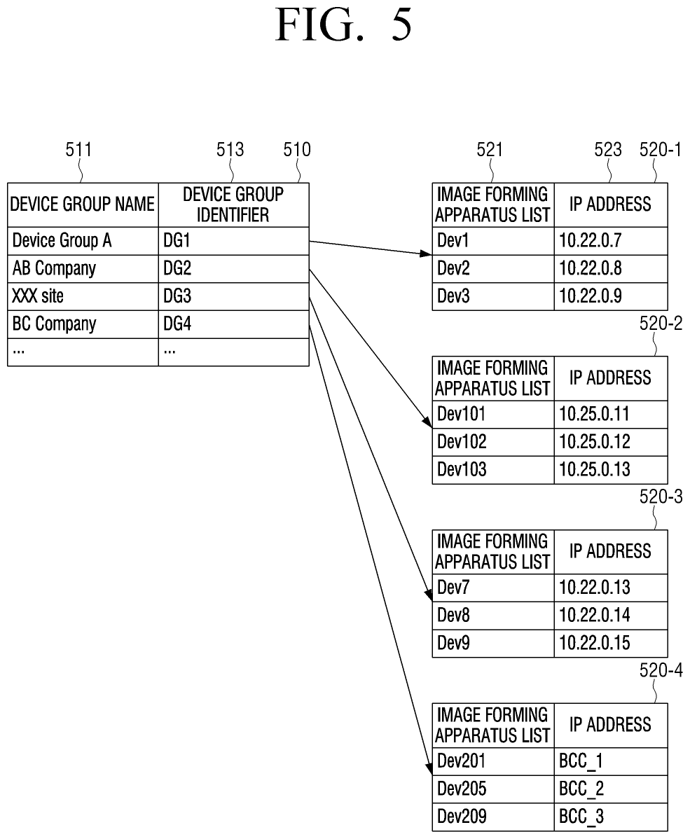

FIG. 5 is a view illustrating group information and device information according to an example.

Referring to FIG. 5, group information 510 may include a device group name 511 and a device group identifier 513. In the example of FIG. 5, one group identifier is given to one group. However, in other examples, one group may have a plurality of identifiers.

The device information 520 (i.e., 520-1, 520-2, 520-3, 520-4) includes information regarding image forming apparatuses that belong to a group. In the example of FIG. 5, the group information 510 includes four groups and thus, four sets of device information 520-1, 520-2, 520-3, and 520-4 are illustrated. However, the number of sets of device information may vary depending on the number of groups in the group information 510.

In addition, the device information 520 may include a device name 521 and address information 523 (e.g., an IP address) of the image forming apparatuses (or printing devices) included in the group. In addition, the device information 520 may include synchronization completion information. In an example, the synchronization completion information may be bit information indicating whether synchronization is completed, or may be time information indicating a synchronization time point.

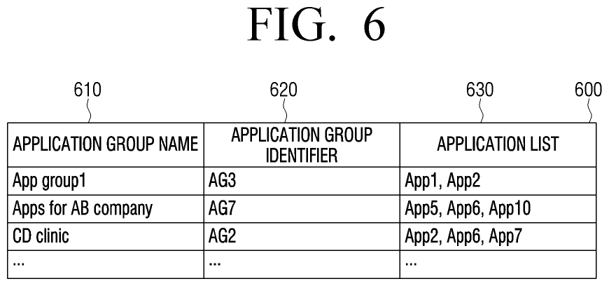

FIG. 6 is a view illustrating application list information according to an example.

Referring to FIG. 6, application list information 600 may include an application group name 610, an application group identifier 620, and an application list 630.

In an example, the server 100 may manage a plurality of groups. In that case, it is possible for the server 100 to manage applications with a different policy for each group. Accordingly, there may be various application policies to be synchronized. In the illustrated example, the server 100 stores three policies.

The application group name 610 may be a name given by a user or a manager with respect to a specific application policy.

The application group identifier 620 is a unique identifier regarding the corresponding application policy. The application group identifier 620 may be automatically assigned according to the generation order of policies.

The application list 630 is an application list to be applied to the corresponding policy, that is, the above-described application list information. For example, if the policy of “App Group 1” is applied to a specific group, the image forming apparatuses in the corresponding group may be synchronized to App 1 and App 2 applications.

In the illustrated example, the application list 630 is in the form of an application list to be synchronized. However, in other examples, the application list 630 may be a combination of a name of a specific application and policy information thereof. For example, it may be configured as ‘App 1 delete’, ‘App 4 install’, etc.

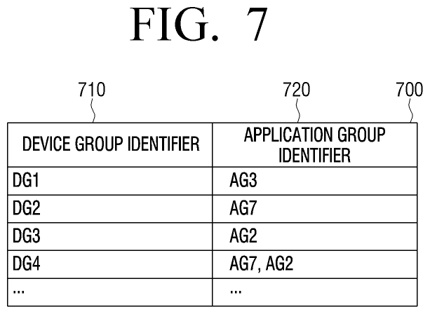

FIG. 7 is a view illustrating group identifier information according to an example.

Referring to FIG. 7, group identifier information 700 includes a device group 710 and an application group 720 that are mapped.

Referring to FIGS. 5 and 6 with respect to the above mapping, three image forming apparatuses (Dev 1, Dev 2, and Dev 3) in the Device Group A (‘DG1’) may be synchronized to have two applications (App1 and App2).

In addition, the three image forming apparatuses (Dev 201, Dev 205, and Dev 209) in the BC Company (‘DG4’) may be synchronized to have six applications (App 5, App 6, App 10, App 2, App 6, and App 7).

For example, in the synchronization operation regarding the BC Company (‘DG4’), the server 100 may transmit the device information 520-4 and the application list information (e.g., App 5, App 6, App 10, App 2, App 6, and App 7) to the BCC_1 which is the address of Dev 201 based on the device information 520-4.

By the above information transmission, once the synchronization in the first image forming apparatus Dev 201 is completed, the first image forming apparatus Dev 201 may transmit the received application list information and the device information to the second device which is Dev 205 in the device information 520-4.

Subsequently, the second image forming apparatus Dev 205, after the synchronization operation, may transmit the received application list information and the device information to the last device which is Dev 209 in the device information 520-4.

After the synchronization operation, the last device (i.e., Dev 209) may notify the server 100 that the synchronization of the corresponding group is completed.

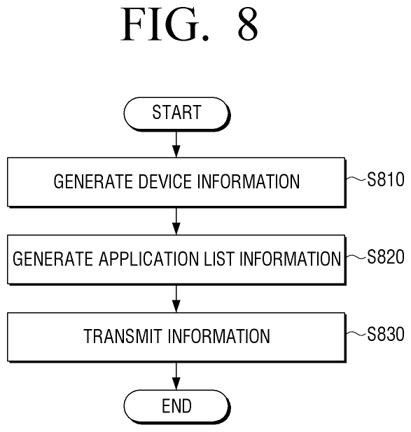

FIG. 8 is a flowchart illustrating an application management method in a server according to an example.

Referring to FIG. 8, device information may be generated in operation S810. For example, device information having address information of a plurality of image forming apparatuses that need to manage applications simultaneously may be generated.

In operation S820, application information may be generated. For example, application information to be commonly applied to the image forming apparatuses in the generated device information may be generated. Such application information may be a list of applications to be maintained by the corresponding image forming apparatuses, or may be information of a specific application and policy information regarding the corresponding application.

The information of the image forming apparatuses and the application information may be transmitted to at least one of a plurality of image forming apparatuses that belong to a group in operation S830. For example, with reference to the device information, the generated information of the image forming apparatuses and the application information may be transmitted to the first image forming apparatus in the device information. If necessary, an installation file regarding a specific application included in the application information can be transmitted together to the corresponding image forming apparatus.

FIG. 8 illustrates and describes that the device information is generated and then, the application is generated. However, in other examples, the application information may be generated in advance and then, the device information may be generated. As illustrated above with respect to FIG. 7, the device information and the application information may be generated in advance regardless of the order, and the above-described generation operation may be substituted by the operation of mapping the two information.

As described above, the application management method in a server according to an example manages applications of each of a plurality of image forming apparatuses through a single setting process.

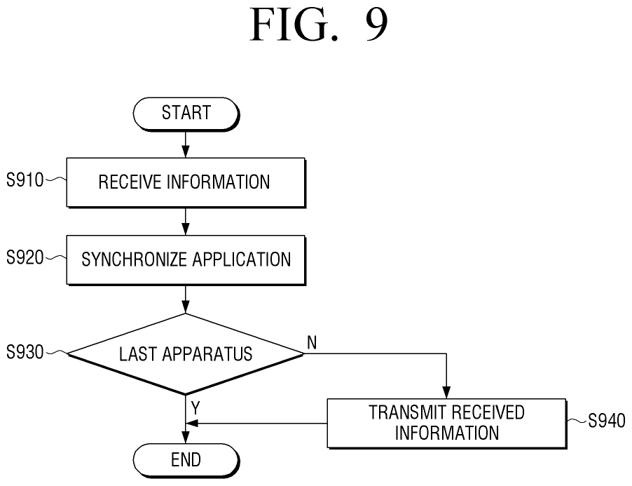

FIG. 9 is a flowchart illustrating an application management method in an image forming apparatus according to an example.

Referring to FIG. 9, the device information of other image forming apparatuses included in a group in which the image forming apparatus belongs and the application information that is commonly applied to the image forming apparatuses in the group may be received in operation S910.

The applications installed in the image forming apparatus may be synchronized based on the received application information in operation S920. For example, an application among the applications installed in the image forming apparatus that is not included in the application list information may be deleted or hidden in the image forming apparatus. If an application included in the application list information is not installed in the image forming apparatus, the application may be newly installed in the image forming apparatus. In addition, if the application information includes policy information for a specific application, operations such as delete/hide/update/install may be performed based on the corresponding policy information.

In operation S930, it may be determined whether the current image forming apparatus is the last apparatus in the device information. For example, it may be determined whether the current image forming apparatus is the last apparatus by determining whether it is in the last location in the device information, or whether the synchronization completion information in the device information is all completed.

If it is determined in operation S930 that the current image forming apparatus is not the last apparatus, when the application synchronization is completed, the received information on the image forming apparatus and the application information may be transmitted to another image forming apparatus in the group based on the device information in operation S940. For example, when the application synchronization is completed, the synchronization completion information in the device information is updated, and the updated device information may be transmitted to another image forming apparatus. If it is determined in operation S930 that the current image forming apparatus is the last apparatus, a separate information transmission operation may not be performed. Instead, the server can be notified that the application synchronization operation in the group is completed.

As described above, an example application management method in the image forming apparatus performs application synchronization by transmitting/receiving necessary information in the image forming apparatuses in the group and thus, the network traffic between the image forming apparatuses and the server can be reduced.

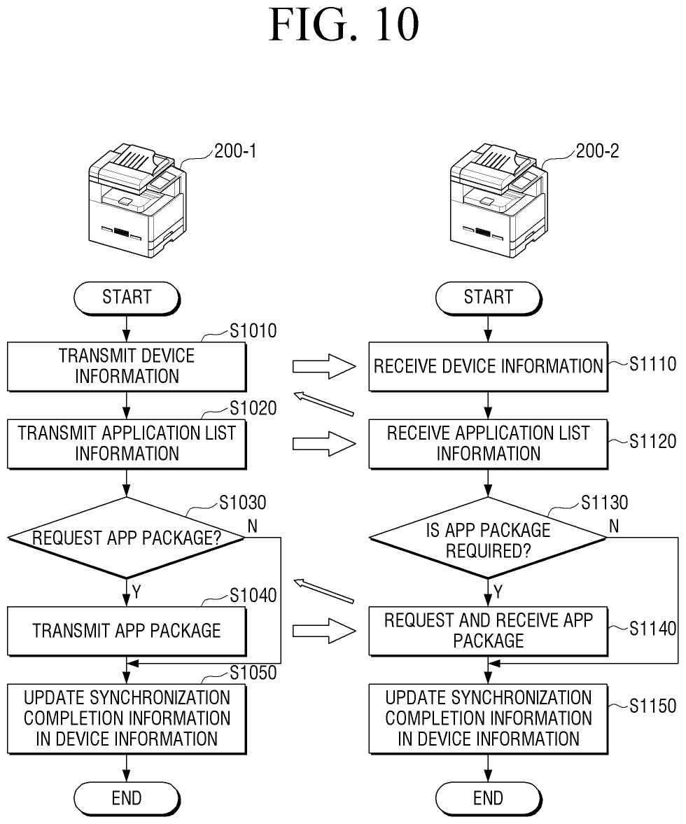

FIG. 10 is a sequence view illustrating an application synchronization operation between a plurality of image forming apparatuses according to an example.

Referring to FIG. 10, a first image forming apparatus 200-1 is an apparatus that has completed a synchronization operation, and a second image forming apparatus 200-2 is an apparatus that starts a synchronization operation. Here, the first image forming apparatus 200-1 may be a first image forming apparatus listed in the device information, and may be an image forming apparatus listed immediately before the second image forming apparatus 200-2 in the device information.

As illustrated in FIG. 10, the first image forming apparatus 200-1 may transmit the device information to the second image forming apparatus 200-2 in operation S1010.

The second image forming apparatus 200-2 may receive the device information and request the application list information from the first image forming apparatus 200-1 in operation S1110. In an example, the second image forming apparatus 200-2 may perform authentication based on the received device information. If the device information is transmitted from an authenticated apparatus, the second image forming apparatus 200-2 may perform a subsequent operation. However, if it is determined that the device information is transmitted from an unauthenticated apparatus, the second image forming apparatus 200-2 may not perform a subsequent operation.

In response to the request for the application list information, the first image forming apparatus 200-1 may transmit the application list information to the second image forming apparatus 200-2 in operation S1020. Accordingly, the second image forming apparatus 200-2 may receive the application list information in operation S1120.

The second image forming apparatus 200-2 which has received the list information may perform a synchronized operation based on the received application list information. If it is determined that new application installation is required in operation S1130, an App package may be requested to the first image forming apparatus 200-1 in operation S1140.

When the App package is requested in operation 51030-Y, the first image forming apparatus 200-1 may transmit the stored App package to the second image forming apparatus 200-2 in operation S1040.

The second image forming apparatus 200-2 that receives the App package may install a new application using the received App package.

When the above process is completed, the first image forming apparatus 200-1 and the second image forming apparatus 200-2 may update the synchronization completion information in the device information in operations S1050 and S1150.

The above-described example application management methods may be implemented as a program and provided to a server or an image forming apparatus. In an example, a program including an application management method may be stored and provided in a non-transitory computer readable medium.

Although examples of the disclosure have been illustrated and described hereinabove, the disclosure is not limited to the specific examples as described above, and may be variously modified by those skilled in the art to which the disclosure pertains without departing from the gist of the disclosure as disclosed in the accompanying claims.

What is claimed is:

1. An image forming apparatus comprising:
a communication device to receive device information regarding image forming apparatuses included in a group to which the image forming apparatus belongs and application list information regarding an application list applied to the image forming apparatuses included in the group; and
a processor to:
synchronize applications installed in the image forming apparatus based on the received application list information, and
control the communication device to transmit the device information and the application list information to another image forming apparatus included in the group to which the image forming apparatus belongs based on the device information.

2. The apparatus as claimed in claim 1, wherein the processor is to delete or limit access to applications that are not included in the application list information.

3. The apparatus as claimed in claim 1, wherein the processor is to install an application that is not installed in the image forming apparatus from among applications included in the application list information, in the image forming apparatus.

4. The apparatus as claimed in claim 1, wherein the communication device is to receive an installation file corresponding to an application that is not installed in the image forming apparatus from another image forming apparatus included in the group.

5. The apparatus as claimed in claim 4, wherein the other image forming apparatus is a first image forming apparatus in the device information or an image forming apparatus that provides the device information to the image forming apparatus.

6. The apparatus as claimed in claim 1, wherein the processor is to update synchronization completion information in the device information upon completion of application synchronization.

7. The apparatus as claimed in claim 6, wherein the processor is to control the communication device to transmit the updated device information to another image forming apparatus.

8. The apparatus as claimed in claim 1,
wherein the device information includes address information and synchronization information of the image forming apparatuses included in the group, and
wherein the processor is to:
determine whether application synchronization of all image forming apparatuses included in the group is completed based on the synchronization information, and
if it is determined that the application synchronization of all image forming apparatuses included in the group is completed, control the communication device to notify a server of completion of synchronization.

9. The apparatus as claimed in claim 1,
wherein the application list information includes a plurality of functions supportable by the image forming apparatus and information regarding an application applied to each of the plurality of functions, and
wherein the processor is to synchronize an application installed in the image forming apparatus using application information corresponding to the function based on a function supported by the image forming apparatus.

10. An application management method comprising:
receiving device information regarding image forming apparatuses included in a group to which an image forming apparatus belongs and application list information regarding an application list applied to the image forming apparatus included in the group;
synchronizing applications installed in the image forming apparatus based on the received application list information; and
transmitting the device information and the application list information to another image forming apparatus included in the group based on the device information.

11. The method as claimed in claim 10, wherein the synchronizing comprises deleting or limiting access to an application that is not included in the application list information from among applications installed in the image forming apparatus.

12. The method as claimed in claim 10, wherein the synchronizing comprises installing an application that is not installed in the image forming apparatus from among applications included in the application list information, in the image forming apparatus.

13. The method as claimed in claim 10, further comprising:
receiving an installation file corresponding to an application that is not installed in the image forming apparatus from another image forming apparatus included in the group.

14. The method as claimed in claim 10,
wherein the device information includes device information and synchronization completion information of the image forming apparatuses in the group, and
wherein the method further comprises:
determining whether application synchronization of all image forming apparatuses included in the group is completed based on the synchronization completion information; and
if it is determined that application synchronization of all image forming apparatuses included in the group is completed, notifying a server of completion of synchronization.

15. The method as claimed in claim 10,
wherein the application list information includes a plurality of functions supportable by the image forming apparatus and information regarding an application applied to each of the plurality of functions, and
wherein the synchronizing comprises synchronizing an application installed in the image forming apparatus using application information corresponding to the function based on a function supported by the image forming apparatus.
